(19) United States
(12) Patent Application Publication
(10) Pub. No.: US 2010/0134837 A1
(43) Pub. Date: Jun. 3, 2010

(54) INTEGRATED DATA PUBLISHING SYSTEM

(76) Inventor: James Michael House, Junction City, OR (US)

Correspondence Address: SQUANK ENTERTAINMENT LLC, 29075 DAVID LANE, JUNCTION CITY, OR, 97448, US

(21) Appl. No.: 12/628,185

(22) Filed: Nov. 30, 2009

Related U.S. Application Data
(60) Provisional application No. 61/200,776, filed on Dec. 3, 2008.

(51) Int. Cl. G06F 15/00

(52) U.S. Cl. 358/1.15

(57) ABSTRACT

An automated system for manufacturing entire data products to retail standards integrates several manufacturing techniques. This system operates with an “on demand” nature, and is customizable. It is comprised of six basic sections interconnected through a computer network. The customer creates an “order” by choosing from prearranged products, or creates a custom “series” of content of various digital data content. Order Management computer servers receive and process orders. The library gathers the content data with batches then further processes the order to be sent to the manufacturing sections. A printing section makes all booklets, liners, and other the printed materials. A publishing section makes the complete data medium. All components are marked with tracking identification like a barcode. The product and order completion section uses tracking to verify the components, assembling and packaging, either manually or automatically. System verifies completion, shipping information is provided, and final product is delivered.

### RELATED APPLICATIONS

The present application is a continuation application of U.S. provisional patent application Ser. No. 61/200,776, filed Dec. 3, 2008, for INTEGRATED DATA PUBLISHING SYSTEM, by James Michael House, included by reference herein and for which benefit of the priority date is hereby claimed.

### FIELD OF THE INVENTION

The present invention relates to customizable physical data mediums and, more particularly, to efficiently facilitate the on demand manufacturing of customizable physical data mediums, such as the DVD, as an entire product ready for sale.

### BACKGROUND OF THE INVENTION

The traditional method for manufacturing disc products such as Compact-Disc (CD), or more specifically the Digital-Versatile-Disc (DVD), is called replication. Before replication is possible, the various data contained on a DVD (video, sound, menu graphics, etc) must be encoded to the disc format. This encoding will happen at a studio, that is sometimes at the manufacturing plant. Replication next involves making “glass masters” that are used to mass produce discs in a press style machine. The disc label is usually applied with the a standard screen printing process. The booklet, liners, covers, and/or any printed materials are usually made by a third party, a traditional off-set printing press company. The process then takes the various components and assembles them to the final “retail-ready” product. This antiquated process with such high-volume requirements and increased overhead is no longer fitting the changing markets. What is needed is an integrated system that can efficiently manufacture disc products, more specifically customizable multimedia products, including all the printed materials to form the entire product ready to sell. This system must be something with a controlled, customizable “on demand” or “make-to-order” nature of operation.

There are a few prior solutions that deal with Compact Discs (CD) manufacturing only, usually pertaining to audio or music. First, U.S. Pat. No. 5,860,068 issued on Jan. 12, 1999, is a method that creates customizable data products like CD and CD-ROM with an emphasis in custom music CDs. Second, U.S. Pat. No. 6,011,758 issued on Jan. 4, 2000 is a method similar to the other in that it creates customizable audio or music CDs.

The invention mentioned in U.S. Pat. No. 5,860,068 is a system just manufacturing the disc itself, more particularly the CD and CD-ROM, and not the entire retail-ready product including the booklets, covers, liners, and other printed materials. Packaging and printed materials are seemingly done the same as older methods, separate by third party manufacturers, if done at all. It does not contain the elements that would make it applicable to multimedia discs like the DVD.

The invention mentioned in U.S. Pat. No. 6,011,758 is far too complex overall, while apparently focused on individual “writing stations”, as opposed to a large-scale manufacturing method. There are several flaws to this systems approach to manufacturing CDs that reduces its effectiveness and practicality for large-scale use. One shortcoming in particular is using a separate printing client for printing disc labels. In a larger manufacturing setup this creates many unneeded complexities significantly reducing control and efficiency. Another shortcoming is using standard computer printers to create required printed materials. Although a standard printer is fine for simple materials like a fact sheet or receipt, such a printer setup is not capable of producing finished booklets, covers, or other standardized packaging materials. Therefore, a standard retail-ready product cannot be created in an automated process. Nor is it setup to be compatible to make multimedia mediums such as the DVD.

### SUMMARY OF THE INVENTION

In accordance with the present invention, there is provided an integrated and automated system or method for improving the manufacturing and distributing of entire data products. A system that will simultaneously manufacture all required artwork, booklets, and other printed material considered part of the standard “retail-ready” product. The system provides item customization and operates with an “on demand” nature while remaining backward compatible with older formats. The best mode for carrying out the invention for multimedia purposes is to work with the data medium of video formatted Digital-Versatile-Disc (DVD) or the like.

The customer creates an “order” by choosing from prearranged products, or creates a custom “series” of content that can include audio, video, and artwork, but extends to any data content. The order is entered into the system at the “Order Receiving” section, by means of communication electronically or manually. Order receiving servers organize the initial order request creating order data like initial customer order tables. Managed on a Storage Area Network (SAN), or equivalent computer system, the new order is sent to the “Order Processing” section. Order processing servers create “batches” containing all required information for content data, encapsulated, while further defining the batch branches, tracking data, job schedules, and other details. After order processing is completed, the batches are sent through the SAN to the library section. The library servers gather the content data using the batches, creating “batch objects” that contain all data required to manufacture the product components. One branch of the batch objects goes to the “Publishing Section”. The Publishing Section is a sub-system comprised of the publishing servers that process data and control publisher devices that write or record data to the medium while simultaneously finishing the label. Another branch of the batch objects goes to the “Printing Section”. The Printing Section is a sub-system comprised of the printing servers that process data and control the “Digital Printing Presses” synchronized with cutting, folding, and other finishing devices that will automatically prepare the printed materials needed for product completion. Both Publishing and Printing Sections will mark all manufactured items with the order tracking identification in the form of a barcode or other similar tracking methods. In the final section, the order completion system, the tracking method or barcode is used to verify the various components of the product through the SAN while the product is assembled and packaged, manually or automatically, for customer fulfillment. Once the item is packaged, the system is notified of completion through the SAN, shipping information is provided, and the final product is delivered.

It would be advantageous to provide a system that is customizable and operates on demand when manufacturing entire digital data products in standard retail packaging.

It would also be advantageous to provide a system that can handle the complexities of customizable multimedia disc manufacturing, such as the DVD, with functions to automate encoding, publishing, printing, and other required processes.

It would further be advantageous to provide a system that uses publishers that write data while also finishing the label, combined with digital printing presses with finishing automation, to make an entire retail-ready product.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram view of an integrated data publishing system; and

FIG. 2 is a detail view of an integrated data publishing system setup for data disc products.

For purposes of clarity and brevity, like elements and components will bear the same designations and numbering throughout the Figures.

### DESCRIPTION OF THE PREFERRED EMBODIMENT

This is a system or method for manufacturing digital data products “on demand” or “make-to-order” in “retail-ready” packaging. The system is focused on making multimedia disc products on demand, such as those like the Digital-Versatile-Disc (DVD) in the standard video formats. The system process can alternately be applied to other data product types such as solid-state or other disc types. Retail-ready is to be considered the standard packaging used to stock equivalent products at a retail store, which could include case cover, tray-liner, a booklet, and similar packaging/product materials.

The system is comprised of six major sections each with their own sub-configuration. Section One “Order Receiving 2” also known as “Order Entry”, Section Two “Order Processing 3”, Section Three “Library 5” also known as “Storage Devices 16”, Section Four “Printing System 13” also known as “Printing 6 Devices”, Section Five “Publishing System 14” also known as “Burning Devices”, and Section Six “Order Completion System 15”. The system sections could be alternately arranged and organized to achieve the same functionality.

All the computer devices are referred to as “servers”. Servers can be defined as a physical piece of computing equipment, or virtual configuration of equivalence operational value, that processes, routes, buffers, and otherwise handles all the data. System sections are linked together apart of a Storage Area Network 12, or equivalent functioning computer system. A Storage Area Network 12 is in itself a collection of computers and storage devices 16, connected over a high-speed network 4 and dedicated to storage and protection of data. A Storage Area Network 12 creates a pool of storage devices 16 with a network 4 used to move data and share data among different servers and devices. Also, the network 4 allows the devices to be connected over long distances as needed.

The “order” for the data product can be received by the system with any means of communications. This can include standard electronic methods such as based on Internet or kiosk (terminal) entry by a customer or business. It can also include communication by written or verbal means such as a mail or phone orders, even business to business purchase orders. Order origination can be apart of, or separate from, the actual manufacturing system. The orders are received into a series of system sections that combine to form the Order Management 1 portion. The order is first received by the “Order Receiving 2” section. The order can be comprised of a prearranged product made by the content creators, or customized by the customer by creating a “series” of content selections coming from various content creators. Customized products can also make available the option for customer to select custom graphics on packaging and printed product materials. Order receiving servers 9 organize the initial order request creating order data like initial customer order tables.

Managed on the Storage Area Network 12 the new system order is sent to “Order Processing 3” section, where computer servers process the order data. Order processing servers 10 create a “batch”, or group of instructions. The batch contains all required information for gathering content data, encapsulated, while further defining the batch branches, or separate sets of instructions used to carry out order fulfillment. A “schedule”, or list of the instructions, components, and system actions needed to complete the process is also created. For purpose of tracking components through manufacturing process, a tracking identification is created and assigned to all components being created. The best mode to actualize such identification would be in a bar-code method. The tracking identification could alternately be done by means of radio frequency identification (RFID) or any other compatible method of tracking identification.

After order processing 3 the batches are sent through the Storage Area Network 12 to the “Library System 11” section. The library 5 is comprised of data storage devices 16 and computer severs. Such storage devices 16 can be made up of any suitable devices available including: optical disc, hard disk drive, solid-state arrays, or the like. The library 5 servers gather the content data using the batches, creating “batch objects” that contain all data required to manufacture the product components. All data necessary for order completion 8 once compiled is sent with batch branches through the Storage Area Network 12 to corresponding system sections as scheduled.

The “Publishing System 14” section receives the corresponding “batch object” branch. The branch contains instructions with all data content (music, video, graphic menus, etc.), to be written or transferred to data medium. It can be any type of data including multimedia, software, and others. It also contains graphic content and tracking identification to be applied to the label of the data medium. The data disc medium is as the best mode for carrying out this system, and it can be of any writable type. The disc format DVD-Recordable (DVD-R) will be used for multimedia purposes. The DVD-R is formatted to be analogous to the standard DVD video format. This method of disc publishing 7 is also compatible with other similar disc formats by changing to other optional types of disc publishers 18. The Publishing 7 Section is a sub-system comprised of computer devices required to make such data medium, retail-ready with the label. These devices are comprised of the publishing 7 servers that are responsible for processing data, and disc publishers 18, or devices that write or record data to the medium while also finishing the label, all in one machine. Customized multimedia orders for a DVD can contain data from various sources that require further processing and encoding before the disc can be made. The publishing 7 servers are used to process, combine, and encode customized multimedia data content to a recordable DVD format, in addition to controlling data flow and operations related to the disc publishers 18. The tracking information, such as a barcode, is made to print on disc during the process. The completed data product is then moved to the order completion system 15, either manually, or through automated process.

The “Printing System 13” of the system receives the corresponding “batch object” branch. The branch contains instructions with all data content related to the artwork or other printed materials. Such printed materials can consist of booklets, tray-cards or tray-liners, case covers, and other similar product components. The Printing 6 Section is a sub-system that consists of the printing 6 servers or computing devices that process data, and the “digital printing presses 17” or similar printing 6 presses that can continuously update the images being pressed by digital means. Also configured with the digital printing presses 17 output are synchronized cutting, folding, and other finishing devices that will automatically prepare the booklets, covers, tray-liners and other printed materials needed for order completion 8. All printed materials will have tracking identification such as barcode relating to order and batch. All separately traceable printed components are then moved manually, or through automation, to the “Order Completion System 15”.

Finally, in the Order Completion System 15, the tracking method or barcode is used to verify the various components of the product through the Storage Area Network 12. Once all components are confirmed the product is assembled and packaged, manually or by automated process. Once the item is assembled the system is notified through the Storage Area Network 12, shipping information is provided. The final data product in its entirety is then ready to be shipped. This can be done on an individual basis direct to end consumer by means of postal services or private parcel. Final data products can also be sent to businesses in larger shipments, usually by means of private parcel services such as FedEx or UPS. Once shipped the order completion system 15 and status update is verified through the system.

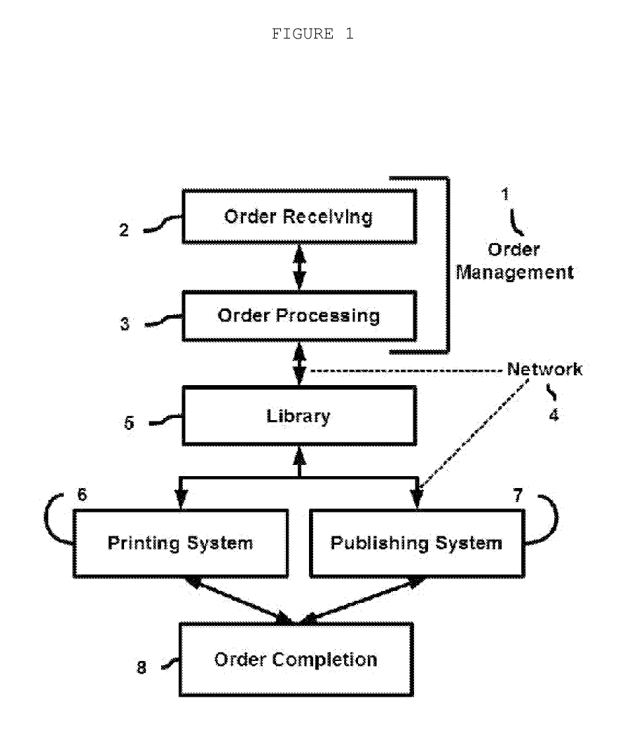

FIG. 1 is a block diagram of the basic process flow of the system. It shows all the major sections communicating through the computer network 4.

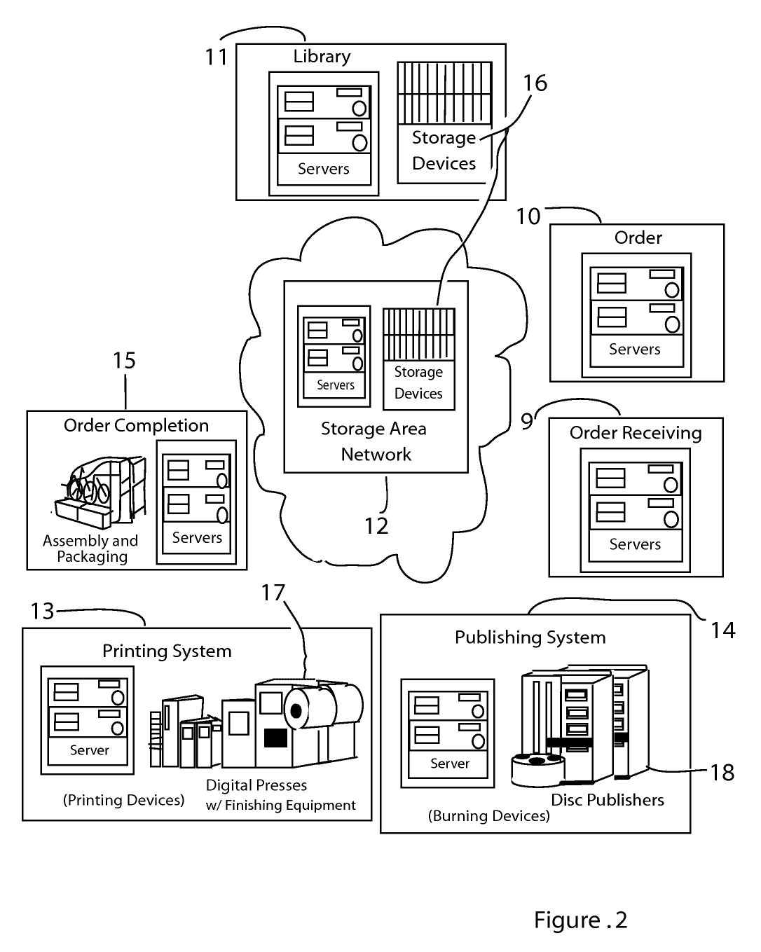

FIG. 2 is a more detailed overview of the system. It shows the configuration of the each sections subsystem when pertaining to disc manufacturing. It also demonstrates the network 4 surrounded by the various sections, the cloud representing its network 4 connectivity to the sections.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An integrated data publishing system for manufacturing and distributing entire customizable data products on demand, including all extraneous components like printed materials to meet retail packaging standards, in one automated process, comprising:
means for creating all the printed material needed for manufacturing the entire data product, retail ready;
means for creating the complete data medium by processing data and writing to medium, while also finishing label; and
means for using the tracking information to verify all product components while assembly and packaging takes place.

2. The integrated data publishing system in accordance with claim 1, wherein said means for creating all the printed material needed for manufacturing the entire data product, retail ready comprises a print server, digital press, finishing equipment configured printing system.

3. The integrated data publishing system in accordance with claim 1, wherein said means for creating the complete data medium by processing data and writing to medium, while also finishing label comprises a publishing server, disc publisher configured publishing system.

4. The integrated data publishing system in accordance with claim 1, wherein said means for using the tracking information to verify all product components while assembly and packaging takes place comprises an order completion system.

5. An integrated data publishing system for manufacturing and distributing entire customizable data products on demand, including all extraneous components like printed materials to meet retail packaging standards, in one automated process, comprising:
a print server, digital press, finishing equipment configured printing system, for creating all the printed material needed for manufacturing the entire data product, retail ready;
a publishing server, disc publisher configured publishing system, for creating the complete data medium by processing data and writing to medium, while also finishing label; and
an order completion system, for using the tracking information to verify all product components while assembly and packaging takes place.

6. An integrated data publishing system for manufacturing and distributing entire customizable data products on demand, including all extraneous components like printed materials to meet retail packaging standards, in one automated process, comprising:
a print server, digital press, finishing equipment configured printing system, for creating all the printed material needed for manufacturing the entire data product, retail ready;
a publishing server, disc publisher configured publishing system, for creating the complete data medium by processing data and writing to medium, while also finishing label; and
an order completion system, for using the tracking information to verify all product components while assembly and packaging takes place.
